(19) United States
(12) Patent Application Publication
(10) Pub. No.: US 2026/0094957 A1
(43) Pub. Date: Apr. 2, 2026

(54) COMBINED MODULE COMPRISING AN ULTRASONIC ELECTRODE CORE CASCADE AND A SEPARATOR

(71) Applicant: Zhijun PENG, Foshan (CN)

(72) Inventor: Zhijun PENG, Foshan (CN)

(21) Appl. No.: 19/012,900

(22) Filed: Jan. 8, 2025

(30) Foreign Application Priority Data
Oct. 2, 2024 (CN) 2024113874553

(51) Int. Cl. H01M 50/70; H01M 50/466

(52) U.S. Cl. CPC H01M 50/70; H01M 50/466

(57) ABSTRACT

A combined module, including a corrugated separator body, first ultrasonic electrode cores, and second ultrasonic electrode cores; the first ultrasonic electrode cores are arranged alongside one of two sides of the corrugated separator body and spaced apart from one another; the second ultrasonic electrode cores are arranged alongside another one of two sides of the corrugated separator body and spaced apart from one another; top and bottom of the corrugated separator body are provided with two fixing plates respectively; the fixing plates are connected to the corrugated separator body, the first ultrasonic electrode cores, and the second ultrasonic electrode cores to form a packaged ultrasonic battery core module; one ends of the first ultrasonic electrode cores are connected through conductive wires to form a first wiring terminal, and one ends of the second ultrasonic electrode cores are connected through conductive wires to form a second wiring terminal.

### BACKGROUND OF THE INVENTION

The present invention relates to the technical field of batteries, and in particular to a battery core module for assembling a battery.

At present, a lithium-ion battery mainly comprises a positive electrode (LiMn2O4 material), a negative electrode (graphite material), electrolyte solution and a separator. When the battery is charged by a power source, electrons on the positive electrode move through an external circuit to the negative electrode, and lithium ions move from the positive electrode into the electrolyte solution, pass through small curved holes on the separator, reach the negative electrode, and combine with the electrons that move to the negative electrode earlier before. When the battery is discharging, the electrons on the negative electrode move through the external circuit to the positive electrode, and the lithium ions move from the negative electrode into the electrolyte solution, pass through the small curved holes on the separator, reach the positive electrode, and then combine with the electrons that move to the positive electrode earlier before.

A battery core of an existing lithium-ion battery is disclosed, for example, in CN214672874U (application No. 202120917584.4) titled “ELECTRODE ASSEMBLY, BATTERY CELL, BATTERY, AND POWER DEVICE”, wherein the electrode assembly (i.e., the battery core) of this prior patent is formed by layers of positive electrode plates and negative electrode plates alternately laminated and wound for numerous times into a coil, where a layer of separator is also disposed between every two adjacent positive electrode plate layer and a negative electrode plate layer; the resulting wound coil is formed as a substantially solid cylindrical body. The battery core structure of this kind has some major disadvantages:

Firstly, because operation of the lithium-ion battery is accompanied by chemical reactions between materials, lithium metal crystals and impurities resulted from the chemical reactions may easily grow at the electrode plates, and their amount may continuously increase along with the service time of the lithium-ion battery. However, there is no space inside this kind of lithium-ion battery core with such a solid structure to accommodate the lithium metal crystals and the chemical impurities, and so the lithium metal crystals and the chemical impurities will adhere to the separators and the electrode plates, thereby forming barriers which do not only block the movements of lithium ions, resulting in the loss of battery capacity and the reduction of charge and discharge efficiency, but also pierces through the separators and hence resulting in great safety hazards due to direct communication between the positive electrode plates and the negative electrode plates that causes short circuit and burning of the battery.

Secondly, in a battery core of such a solid structure, the electrolyte can only be stored between a separator and a corresponding electrode plate by electrolyte infiltration, therefore, the amount of electrolyte stored in each battery core is small, which greatly affects the number of charge and discharge cycle of the lithium-ion battery, and results in a short service life of the lithium-ion battery.

Thirdly, in the charge or discharge process of such a battery core with a solid structure, it is difficult for the lithium-ion battery to dissipate heat to the external environment, and this leads to great safety hazards due to a quick rise of the temperature in the lithium-ion battery core. Therefore, it is necessary to equip a more powerful heat dissipation and cooling system during use of the lithium-ion battery core. However, operation of the heat dissipation and cooling system may consume part of the electricity stored in the battery, thereby resulting in a short endurance time of the lithium-ion battery.

Fourthly, because an environmental temperature for operation of a lithium-ion battery is 0-40° C. When the environmental temperature is lower than 0° C., the capillaries, also commonly known as “small holes”, on the separator shrink due to the principle of thermal expansion and contraction. Therefore, the lithium ions are difficult or unable to pass through the separator; also, the lithium ions may easily condense in the electrolyte solution and move slowly in the electrolyte solution; as a result, the lithium ion battery cannot be charged and discharged normally, and the overall performance of the battery will be weakened. In this regard, the current solution is to heat up the lithium-ion battery by using a heat dissipation and cooling system. However, operation of the heat dissipation and cooling system may consume part of the electricity stored in the battery, therefore resulting in a short endurance of the lithium-ion battery.

In summary, there are still many problems to be solved in the current battery core having a solid structure.

### BRIEF SUMMARY OF THE INVENTION

The present invention intends to solve the above problems and disadvantages by providing a combined module comprising an ultrasonic electrode core cascade and a separator, which utilizes a corrugated separator body and ultrasonic electrode cores arranged at two sides of the corrugated separator body respectively to create more vacant spaces inside a battery module. These vacant spaces are beneficial to quick conduction of the heat of the battery to an external environment and enhancement of heat dissipation of the battery itself. Also, these vacant spaces can also increase the amount of electrolyte that can be filled into the battery so as to prolong the service life of the battery. Moreover, the vacant spaces can also accommodate lithium metal crystalline substances and other chemical impurities formed after chemical reactions of the battery. Further, an ultrasonic cavitation effect generated by the ultrasonic electrode cores ensures that the lithium metal crystals will not be bonded to the separator and the ultrasonic electrode cores, thereby greatly prolonging the service life of the battery and improving the safety performance of the battery.

The technical solutions of the present invention are achieved as follows:

A composite module, comprising ultrasonic electrode cores and a corrugated separator body; the ultrasonic electrode cores comprises a plurality of first ultrasonic electrode cores and a plurality of second ultrasonic electrode cores; the first ultrasonic electrode cores are arranged alongside one of two sides of the corrugated separator body vertically along a widthwise direction of the corrugated separator body and spaced apart from one another along a lengthwise direction of the corrugated separator body; the second ultrasonic electrode cores are arranged alongside another one of two sides of the corrugated separator body vertically along the widthwise direction of the corrugated separator body and spaced apart from one another along a lengthwise direction of the corrugated separator body; two fixing plates are positioned at an upper end and a lower end of the corrugated separator body respectively; the corrugated separator body, the first ultrasonic electrode cores, and the second ultrasonic electrode cores are connected to the two fixing plates such that the corrugated separator body, the first ultrasonic electrode cores, and the second ultrasonic electrode cores are packaged between the two fixing plates and fixed with the two fixing plates to form an integral ultrasonic battery core module; one ends of the first ultrasonic electrode cores are connected in series through a first conductive wire to form a first wiring terminal, and one ends of the second ultrasonic electrode cores are connected in series through a second conductive wire to form a second wiring terminal.

Further, the first ultrasonic electrode cores are arranged in groups each consisting of three first ultrasonic electrode cores positioned with respect to one another in a triangular shape.

Further, the second ultrasonic electrode cores are arranged in groups each consisting of three second ultrasonic electrode cores positioned with respect to one another in a triangular shape.

Further, a top edge of the upper end of the corrugated separator body and a bottom edge of the lower end of the corrugated separator body are each provided with a projected insertion strip; each of the two fixing plates is correspondingly provided with a fitting groove which is sealingly inserted by a corresponding projected insertion strip.

The present invention has the following beneficial effects:

(1) According to the present invention, after the battery is assembled by using the corrugated separator body, operating surface areas of the separator is effectively increased given that the size of the battery remains unchanged, accordingly, the density of the battery can be increased and the storage capacity of electricity can be improved.

(2) By using the corrugated separator body and a plurality of ultrasonic electrode cores arranged at front and rear sides of the separator, after the battery is assembled, more vacant spaces can be formed between the front and rear sides of the separator and inner walls of the battery housing; the vacant spaces can increase the amount of electrolyte filled into the battery so as to prolong the service life of the battery, and enhance the electric storage capacity of the battery. The vacant spaces can be beneficial to quickly conducting the heat of the battery to an external environment and enhancing the heat dissipation performance of the battery itself. The vacant spaces can also accommodate lithium metal crystalline substances and other chemical impurities formed after chemical reactions of the battery. Moreover, an ultrasonic cavitation effect generated by the ultrasonic electrode cores ensures that the lithium metal crystals will not be bonded to the separator and the ultrasonic electrode cores, thereby effectively avoiding the hazards of blocking and puncturing the separator by the lithium metal crystals and the chemical impurities, greatly prolonging the service life of the battery, and improving the safety performance of the battery.

(3) Movement of the electrolyte can be accelerated by utilizing the ultrasonic cavitation effect generated by the ultrasonic electrode cores, such that when the battery operates, the heat generated inside the battery can be quickly conducted to the external environment, thereby reducing the safety hazards of the battery, and improving the safety performance of the battery.

(4) When the battery is charged, the movement of the electrolyte can be accelerated by utilizing the ultrasonic cavitation effect generated by the ultrasonic electrode cores, such that the movement of lithium ions is accelerated, and the charging speed and efficiency can be improved.

(5) The present invention arranges a plurality of ultrasonic electrode cores along two sides (front and rear sides) of the separator, such that a positive electrode and a negative electrode of the battery are in each case operated by an array of ultrasonic electrode cores composed of a plurality of ultrasonic electrode cores that works synchronously, thereby greatly improving the charging and discharging power of the battery.

(6) The movement of the electrolyte is accelerated by utilizing the ultrasonic cavitation effect generated by the ultrasonic electrode cores, thereby avoiding and solving the problem that the battery cannot be charged or discharged due to poor fluidity and coagulation of the electrolyte in an extremely cold environment.

(7) The technical solutions of the present invention can be suitable for producing chemical batteries such as lithium-ion batteries, carbon-zinc batteries, alkaline batteries, lithium-manganese batteries, lithium thionyl chloride batteries, zinc-manganese batteries, zinc-silver batteries, zinc-air batteries, lithium-iron batteries, lead-acid storage batteries, and nickel-hydrogen storage batteries.

### BRIEF DESCRIPTION OF THE DRAWINGS

FIG. 1 is a schematic diagram of an overall structure of the present invention;

FIG. 2 is a schematic cross-sectional view at section A-A in FIG. 1 of the present invention;

FIG. 3 is a schematic diagram of an exploded structure of the present invention;

FIG. 4 is a schematic perspective view of an ultrasonic battery core module with a partially enlarged cross-sectional view thereof according to the present invention;

FIG. 5 is a schematic perspective view of a battery housing of the present invention;

FIG. 6 is a schematic diagram of an overall structure of a first ultrasonic electrode core or a second ultrasonic electrode core of the present invention;

FIG. 7 is a schematic diagram of a partial structure of a first ultrasonic electrode core or a second ultrasonic electrode core of the present invention; and

FIG. 8 is a schematic diagram of an exploded structure of a first ultrasonic electrode core or a second ultrasonic electrode core of the present invention.

### DETAILED DESCRIPTION OF THE INVENTION

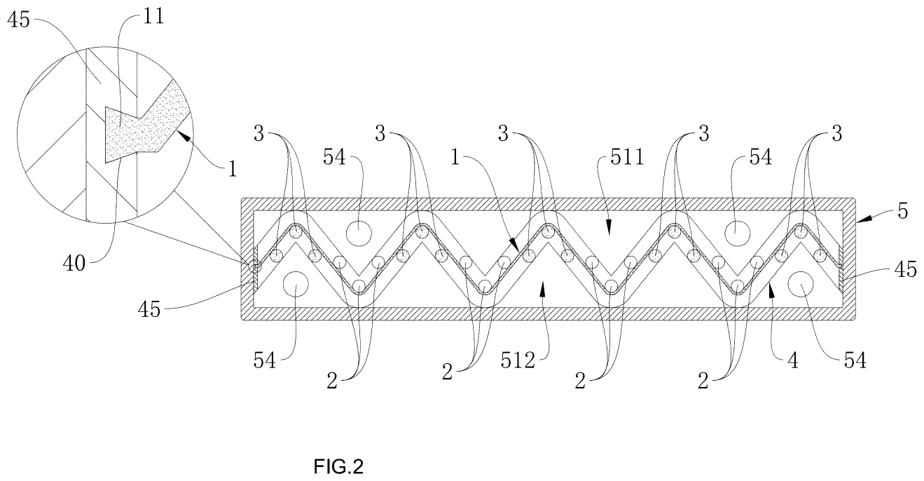

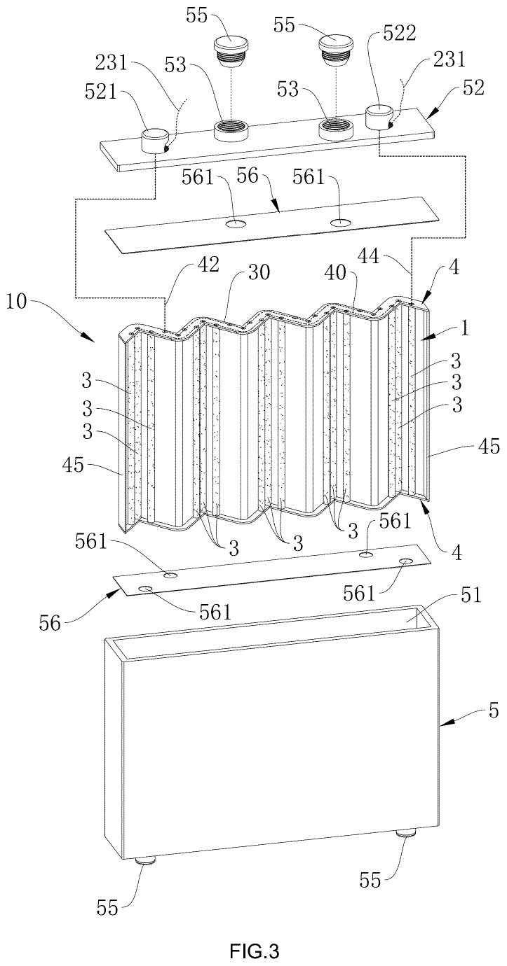

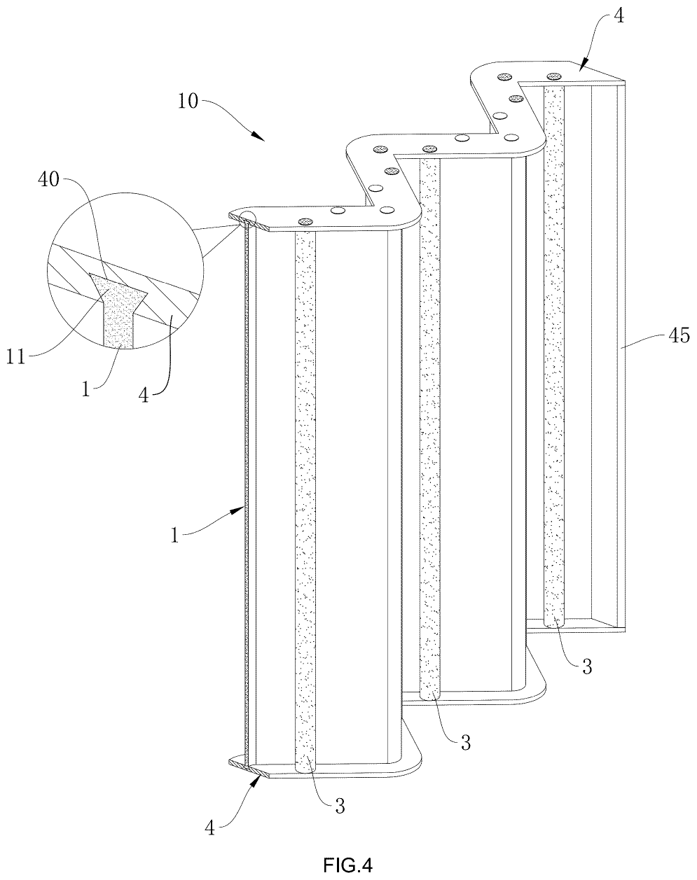

The present invention relates to a combined module comprising an ultrasonic electrode core cascade and a separator. Said combined module is a battery core module assembly used for assembling an ultrasonic battery product. Said combined module comprises ultrasonic electrode cores in-built with ultrasonic modules; for the ease of describing the structures of the present invention clearly, said ultrasonic electrode cores of the present invention will be described as first ultrasonic electrode cores and second ultrasonic electrode cores below. The separator of the present invention is the same as a conventional battery separator. The battery separator, embodied as a film, is positioned between a positive electrode and a negative electrode of the battery, and is a critical component of the battery, and has a direct impact on the safety and the cost of the battery. A main function of the battery separator is to isolate the positive electrode and the negative electrode, such that electrons in the battery cannot pass through the separator directly, but ions in the electrolyte are allowed to pass through the separator freely between the positive electrode and the negative electrode. In order to achieve the purposes of the present invention, as shown in FIGS. 2 and 4, the composite module comprises a corrugated separator body 1, a plurality of first ultrasonic electrode cores 2, and a plurality of second ultrasonic electrode cores 3; the first ultrasonic electrode cores 2 are arranged alongside one of two sides of the corrugated separator body 1 vertically along a widthwise direction of the corrugated separator body 1 and spaced apart from one another along a lengthwise direction of the corrugated separator body 1; the second ultrasonic electrode cores 3 are arranged alongside another one of two sides of the corrugated separator body 1 vertically along the widthwise direction of the corrugated separator body 1 and spaced apart from one another along a lengthwise direction of the corrugated separator body 1; two fixing plates 4 are positioned at an upper end and a lower end of the corrugated separator body 1 respectively; the corrugated separator body 1, the first ultrasonic electrode cores 2, and the second ultrasonic electrode cores 3 are connected to the two fixing plates 4 such that the corrugated separator body 1, the first ultrasonic electrode cores 2, and the second ultrasonic electrode cores 3 are packaged between the two fixing plates 4 and fixed with the two fixing plates 4 to form an integral ultrasonic battery core module 10. As shown in FIG. 3, the first ultrasonic electrode cores 2 have their respective one ends connected in series through a first conductive wire 30 to form a first wiring terminal 42, and the second ultrasonic electrode cores 3 have their respective one ends connected in series through a second conductive wire 40 to form a second wiring terminal 44. The first wiring terminal 42 and the second wiring terminal 44 are used to connect with a first wiring post 521 and a second wiring post 522 respectively on a housing.

As shown in FIG. 2, the first ultrasonic electrode cores 2 are arranged in groups each consisting of three first ultrasonic electrode cores 2 positioned with respect to one another in a triangular shape, and all groups of said first ultrasonic electrode cores 2 are evenly spaced apart from one another along one of two sides of the corrugated separator body 1, so as to limit a shape of said one of two sides of the corrugated separator body 1. Similarly, the second ultrasonic electrode cores 3 are arranged in groups each consisting of three second ultrasonic electrode cores positioned with respect to one another in a triangular shape, and all groups of said second ultrasonic electrode cores 3 are evenly spaced apart from one another along another one of two sides of the corrugated separator body 1, so as to limit a shape of said another one of two sides of the corrugated separator body 1. As shown in FIG. 2, the groups of first ultrasonic electrode cores 2 and the groups of second ultrasonic electrode cores 3 are alternately and staggeredly arranged, and said one of two sides of the corrugated separator body 1 extends along at least two outer sides of each triangular shape defined by each of the groups of first ultrasonic electrode cores 2, and said another one of two sides of the corrugated separator body 1 extends along at least two outer sides of each triangular shape defined by each of the groups of second ultrasonic electrode cores 3, so that the corrugated separator body 1 meanders in a corrugated shape as shown in FIG. 2. Alternatively, the corrugated separator body 1 may be a separator having a corrugated shape manufactured in advance, so that the corrugated shape of the corrugated separator body 1 needs not to be shaped and formed by the groups of first ultrasonic electrode cores 2 and the groups of second ultrasonic electrode cores 3 arranged and positioned in the particular ways as described above.

Further, as shown in FIG. 4, in order to ensure sealing performance of an upper end and a lower end of the ultrasonic battery core module 10 to prevent electrons of the positive and negative electrodes from directly passing through gaps between the two fixing plates 4 and the corrugated separator body 1, a top edge of the upper end of the corrugated separator body 1 and a bottom edge of the lower end of the corrugated separator body 1 are each provided with a projected insertion strip 11; each of the two fixing plates 4 is correspondingly provided with a fitting groove 40 which is sealingly inserted by a corresponding projected insertion strip 11 according to conventional tenon and mortise joint mechanism, and sealing adhesive is applied between each projected insertion strip 11 and the corresponding fitting groove 40; accordingly, sealed and firm connection between the two fixing plates 4 and the corrugated separator body 1 can be ensured.

As shown in FIG. 3, vertical shaping plates 45 are further disposed at a left end and a right end of the corrugated separator body 1 respectively; an upper end and a lower end of each of the vertical shaping plates 45 are fixedly connected to the two fixing plates 4 respectively. The fixed connection between the vertical shaping plates 45 and the two fixing plates 4 can be fixed connection realized by welding, or by cooperative screws and screw holes. According to the present invention, by providing the vertical shaping plates 45, the structural strength of the entire ultrasonic battery core module 10 can be enhanced, and the corrugated separator body 1 is tensioned in a vertically upright state and will not easily deform. Moreover, as shown in FIG. 2, in order to ensure sealed connection between each of the left end and the right end of the corrugated separator body 1 and a corresponding vertical shaping plate 45, each of the left end and the right end of the corrugated separator body 1 is also provided with a projected insertion strip 11, and each of the vertical shaping plates 45 is correspondingly provided with a fitting groove 40 which are sealingly inserted by a corresponding projected insertion strip 11 according to conventional tenon and mortise joint mechanism, and sealing adhesive is applied between each projected insertion strip 11 and the corresponding fitting groove 40; accordingly, sealed and firm connection between the vertical shaping plates 45 and the corrugated separator body 1 can be ensured.

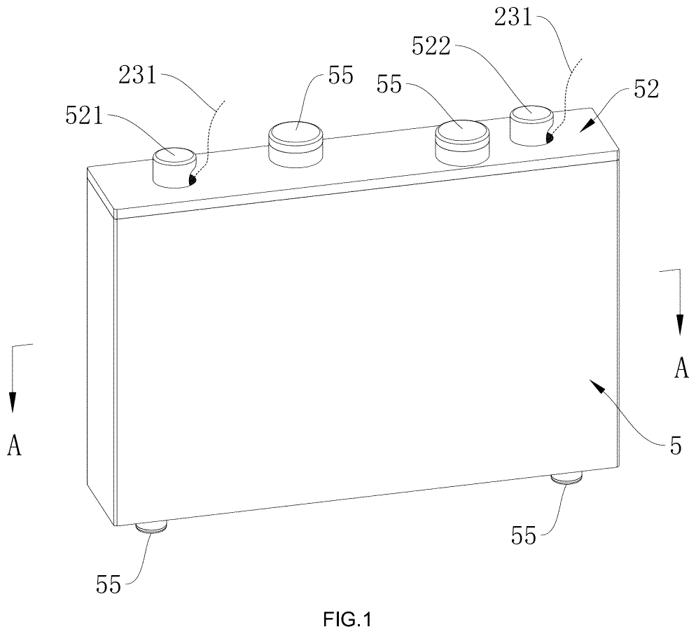

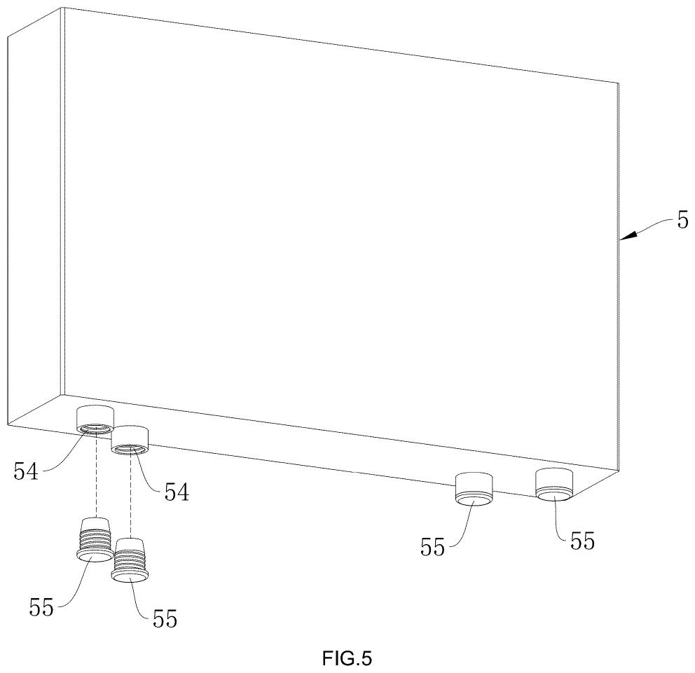

In order to package the ultrasonic battery core module 10 into a complete battery, as shown in FIGS. 1, 2, 3 and 5, the present invention further comprises a housing 5 with an accommodating cavity 51, and a cover shell 52. The ultrasonic battery core module 10 is nested in the accommodating cavity 51; as shown in FIG. 2, the accommodating cavity 51 is partitioned by the ultrasonic battery core module 10 into a first working chamber 511 and a second working chamber 512; after the complete battery is made, electrolyte is filled into both the first working chamber 511 and the second working chamber 512 to form two independent working chambers of a positive electrode and a negative electrode of the battery respectively. The first working chamber 511 and the second working chamber 512 are separated by the corrugated separator body 1, where only ions in the electrolyte can pass through the corrugated separator body 1, and this principle is the same as that of a conventional battery, and so will not described in detail herein. One of the first working chamber 511 and the second working chamber 512 is responsible for realizing the positive electrode of the battery, and another one of the first working chamber 511 and the second working chamber 512 is responsible for realizing the negative electrode of the battery.

As shown in FIG. 1 and FIG. 3, the cover shell 52 covers an opening of the accommodating cavity 51 of the housing 5, and the cover shell 52 is further provided with a first wiring post 521 and a second wiring post 522 electrically connected to the first wiring terminal 42 and the second wiring terminal 44 respectively.

In order to facilitate filling or replenishing of the electrolyte, and to facilitate discharging of used electrolyte when renewing the battery, as shown in FIGS. 1, 3 and 5, the cover shell 52 is further provided with filling ports 53 connected to the first working chamber 511 and the second working chamber 512 respectively; a bottom side of the housing 5 is further provided with drain ports 54 connected to the first working chamber 511 and the second working chamber 512 respectively; each of the filling ports 53 and the drain ports 54 is provided with a reusable sealing cap 55. The sealing cap 55 is removably connected with a corresponding filling port 53 or drain port 54 by for example threaded connection or buckling. When the battery needs to be renewed or maintained, the electrolyte of the battery can be conveniently filled in and discharged only by opening the sealing caps 55 without the need to disassemble the cover shell 52. Also, the electrolyte can be conveniently replaced by utilizing the filling ports 53 and the drain ports 54, and the interior of the battery can be ultrasonically cleaned by using the ultrasonic cavitation effect of the ultrasonic electrode cores when the electrolyte is replaced, such that the service life of the battery can be greatly prolonged through cleaning and renewing the electrolyte.

As shown in FIG. 3, a sealing gasket 56 is further disposed between the ultrasonic battery core module 10 and the cover shell 52, and another sealing gasket 56 is further disposed between the ultrasonic battery core module 10 and an inner bottom surface of the accommodating cavity 51. With the sealing and buffering functions of the sealing gaskets 56, when the ultrasonic battery core module 10 is assembled by being nested in the housing 5, gaps between the upper end of the ultrasonic battery core module 10 and the battery housing 5 and between the lower end of the ultrasonic batter core module 10 can be eliminated, and thus the first working chamber 511 and the second working chamber 512 can be sealed independently and will not communicate with each other, so as to prevent short circuit in the battery and improve the safety and reliability of the battery. Through holes 561 are formed on the sealing gaskets 56 at positions corresponding to the filling ports 53 and the drain ports 54 to prevent the filling ports 53 and the drain ports 54 from being blocked. The sealing gaskets 56 are typically made of a corrosion-resistant rubber material.

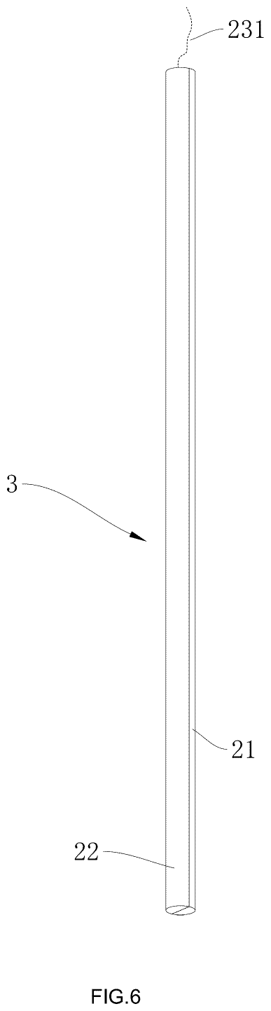

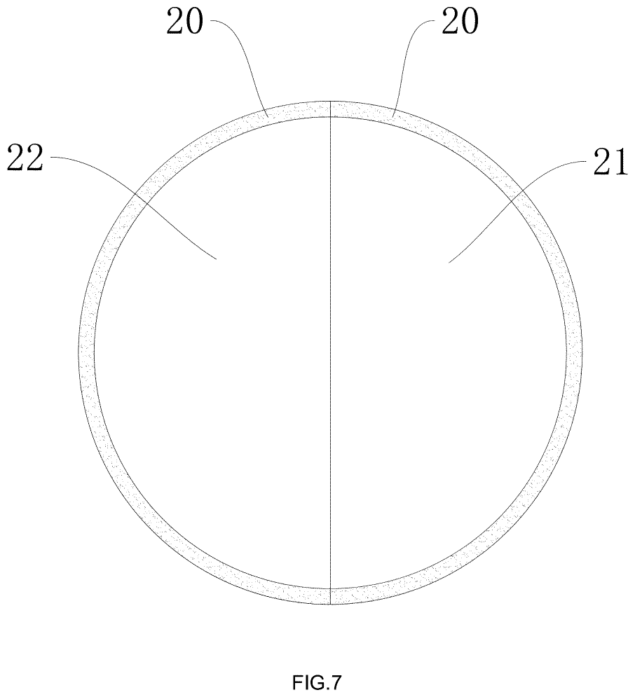

As shown in FIGS. 6, 7, and 8, each of the ultrasonic electrode cores comprises an elongated housing 21 with an operating groove 211, a slidable block 24 disposed in the operating groove 211, and an elongated cover shell 22 covering the operating groove 211. The slidable block 24 is provided with at least one permanent magnet 25; at least one electromagnetic coil 23 interacting with said at least one permanent magnet 25 is arranged at an inner side of the elongated cover shell 22; resilient tabs 26 providing a buffering function are arranged at two ends of the slidable block 24 respectively; outer surfaces of the elongated housing 21 and the elongated cover shell 22 are coated with conductive coating 20. By providing the conductive coating 20, the conductive coating 20 of each of the ultrasonic electrode cores is electrically conducted with the electrolyte to transfer electrons to the electrolyte. Said ultrasonic electrode cores comprises the first ultrasonic electrode cores 2 and the second ultrasonic electrode cores 3.

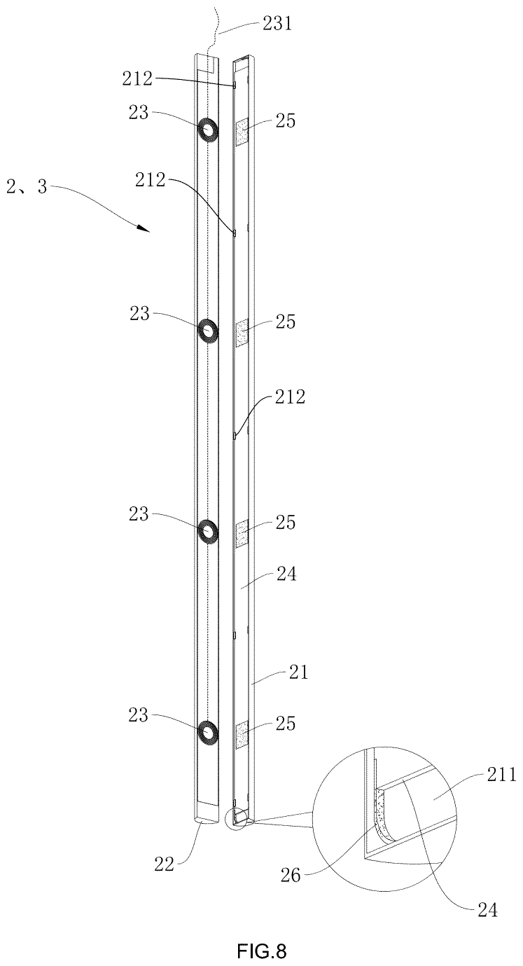

As shown in FIG. 8, the operating groove 211 is further provided with limiting protrusions 212 for preventing the slidable block 24 from being disengaged from the operating groove 211. By arranging the resilient tabs 26, when said at least one electromagnetic coil 23 drives said at least one permanent magnet 25 and thus the slidable block 24 to move, the resilient tabs 26 can provide a reactive force to bounce back the slidable block 24, so that the slidable block 24 can achieve a high-speed reciprocating motion under the effect of mutually reversing magnetic fields of said at least one electromagnetic coil 23 and said at least one permanent magnet 25, thereby generating ultra-high frequency vibration, i.e. ultrasonic high frequency vibration, which propagates in a medium such as a liquid to form ultrasonic waves. Ultrasonic module adopting the above structures consisting of the operating groove 211, said at least one electromagnetic coil 23, the slidable block 24, and said at least one permanent magnet 25 enables the first ultrasonic electrode cores 2 and the second ultrasonic electrode cores 3 to be made into an even smaller size with higher vibration frequency. The elongated housing 21 and the elongated cover shell 22 are both made of metal materials. Each of the first ultrasonic electrode cores 2 and the second ultrasonic electrode cores 3 can be made into a shape of a cylinder, an elliptic cylinder, or other cylindrical shapes.

As shown in FIGS. 1, 3, 6 and 8 after passing through the elongated cover shell 22, the lead 231 of said at least one electromagnetic coil 23 (of each of the first ultrasonic electrode cores 2) for providing power supply can be wound together with the first conductive wire 30 and the first wiring terminal 42 to form a composite wire, and the lead 231 of said at least one electromagnetic coil 23 (of each of the second ultrasonic electrode cores 3) for providing power supply can be wound together with the second conductive wire 40 and the second wiring terminal 44 to form another composite wire; at the first wiring post 521 and the second wiring post 522, the leads 231 in both composite wires are again separated from the composite wires and then being led out of the housing 5 from sides of the first wiring post 521 and the second wiring post 522 respectively, while the first wiring terminal 42 is then connected with the first wiring post 521 and the second wiring terminal 44 is then connected with the second wiring post 522. The present invention may alternatively use an ultrasonic vibration motor or an ultrasonic transducer in lieu of the ultrasonic electrode core having the structures described above.

In order to control the electromagnetic coils 23 of the first ultrasonic electrode cores 2 and the second ultrasonic electrode cores 3 to operate, a circuit board module connected with the leads 231 of the first ultrasonic electrode cores 2 and the second ultrasonic electrode cores 3 is generally disposed outside the housing, and the electromagnetic coils 23 inside the first ultrasonic electrode cores 2 and the second ultrasonic electrode cores 3 are controlled uniformly through a control chip and a control switch of the circuit board module. Also, the circuit board module may be further provided with a Bluetooth® communication module, a WiFi® communication module, or the like. The communication module is used for accessing the Internet, and the battery is monitored and controlled by means of a computer, a smart phone, or the like connected to the Internet.

What is claimed is:

1. A combined module, comprising ultrasonic electrode cores, and a corrugated separator body; the ultrasonic electrode cores comprises a plurality of first ultrasonic electrode cores and a plurality of second ultrasonic electrode cores; the first ultrasonic electrode cores are arranged alongside one of two sides of the corrugated separator body vertically along a widthwise direction of the corrugated separator body and spaced apart from one another along a lengthwise direction of the corrugated separator body; the second ultrasonic electrode cores are arranged alongside another one of two sides of the corrugated separator body vertically along the widthwise direction of the corrugated separator body and spaced apart from one another along a lengthwise direction of the corrugated separator body; two fixing plates are positioned at an upper end and a lower end of the corrugated separator body respectively; the corrugated separator body, the first ultrasonic electrode cores, and the second ultrasonic electrode cores are connected to the two fixing plates such that the corrugated separator body, the first ultrasonic electrode cores, and the second ultrasonic electrode cores are packaged between the two fixing plates and fixed with the two fixing plates to form an integral ultrasonic battery core module; one ends of the first ultrasonic electrode cores are connected in series through a first conductive wire to form a first wiring terminal, and one ends of the second ultrasonic electrode cores are connected in series through a second conductive wire to form a second wiring terminal.

2. The combined module of claim 1, wherein the first ultrasonic electrode cores are arranged in groups each consisting of three first ultrasonic electrode cores positioned with respect to one another in a triangular shape.

3. The combined module of claim 2, wherein the second ultrasonic electrode cores are arranged in groups each consisting of three second ultrasonic electrode cores positioned with respect to one another in a triangular shape.

4. The combined module of claim 1, wherein a top edge of the upper end of the corrugated separator body and a bottom edge of the lower end of the corrugated separator body are each provided with a projected insertion strip; each of the two fixing plates is correspondingly provided with a fitting groove which is sealingly inserted by a corresponding projected insertion strip.

5. The combined module of claim 4, wherein vertical shaping plates are further disposed at a left end and a right end of the corrugated separator body respectively; an upper end and a lower end of each of the vertical shaping plates are fixedly connected to the two fixing plates respectively.

6. The combined module of claim 5, wherein each of the left end and the right end of the corrugated separator body is also provided with a projected insertion strip, and each of the vertical shaping plates is correspondingly provided with a fitting groove which are sealingly inserted by a corresponding projected insertion strip on a corresponding left end or right end of the corrugated separator body.

7. The combined module of claim 1, further comprising a housing with an accommodating cavity, and a cover shell; the ultrasonic battery core module is nested in the accommodating cavity; the accommodating cavity is partitioned by the ultrasonic battery core module into a first working chamber and a second working chamber; the cover shell covers an opening of the accommodating cavity of the housing, and the cover shell is further provided with a first wiring post and a second wiring post electrically connected to the first wiring terminal and the second wiring terminal respectively.

8. The combined module of claim 7, wherein the cover shell is further provided with filling ports connected to the first working chamber and the second working chamber respectively; a bottom side of the housing is further provided with drain ports connected to the first working chamber and the second working chamber respectively; each of the filling ports and the drain ports is provided with a reusable sealing cap.

9. The combined module of claim 7, wherein a sealing gasket is further disposed between the ultrasonic battery core module and the cover shell, and another sealing gasket is further disposed between the ultrasonic battery core module and an inner bottom surface of the accommodating cavity.

10. The combined module of claim 1, wherein each of the first ultrasonic electrode cores and the second ultrasonic electrode cores comprises an elongated housing with an operating groove, a slidable block disposed in the operating groove, and an elongated cover shell covering the operating groove; the slidable block is provided with at least one permanent magnet; at least one electromagnetic coil interacting with said at least one permanent magnet is arranged at an inner side of the elongated cover shell; resilient tabs providing a buffering function are arranged at two ends of the slidable block respectively; outer surfaces of the elongated housing and the elongated cover shell are coated with conductive coating.
